(19) United States
(12) Patent Application Publication
(10) Pub. No.: US 2008/0129719 A1
(43) Pub. Date: Jun. 5, 2008

(54) ELECTRONIC DEVICE AND METHOD FOR CONTROLLING THE ILLUMINATION OF A DISPLAY AND/OR A KEYPAD THEREOF

(76) Inventors: Marten Andreas Jonsson, Malmo (SE); Peter Mikael Peterson, Malmo (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/566,461

(22) Filed: Dec. 4, 2006

(51) Int. Cl. G09G 5/00

(52) U.S. Cl. 345/206

(57) ABSTRACT

An electronic device for controlling the illumination of a display and/or a keypad thereof. The electronic device comprises a user interface with a display and a keypad. A lighting device is adapted to provide an illumination effect to the display and/or the keypad to thereby illuminate at least one of the display and the keypad. The electronic device further comprises a calendar unit. A detector coupled to the calendar unit is adapted to detect a calendar event, e.g. a certain day, month, year, meeting appointment, etc. that is generated from the calendar unit. Also, a controller is coupled to the lighting device and the detector, wherein the controller is adapted to control the illumination effect of the lighting device in dependence of the detected calendar event. The invention also concerns a method and a computer program product.

### TECHNICAL FIELD

The present invention relates in general to electronic devices, e.g. mobile telephones, and more particularly to the illumination of the keypad and/or the display of such electronic devices. The invention also relates to a method and a computer program product for controlling the illumination of the keypad and/or the display of an electronic device.

### DESCRIPTION OF RELATED ART

Electronic devices, e.g. mobile telephones, smart phones, Personal Digital Assistants (PDA's), computers and the like are widely used today. Such devices include a user interface (UI). The user interface includes an input UI for inputting information and commands to the electronic device. The input UI may include one or more of the devices selected from the group comprising: a microphone, an alphanumeric keypad with one or more keys, a joystick, a rockerpad, a touch screen, and a scroll button such as a jog dial. The user interface also includes an output UI for displaying or rendering information or data. The output UI may include one or more of the devices selected from the group comprising: a loudspeaker, a vibrator, and a display.

Historically, the user experience from electronic devices has been relatively constant over time. However, there is a now a trend towards it being increasingly popular to change or personalize the user experience of electronic devices, e.g. by changing or personalizing the experience or appearance of the electronic devices during the lifetime of the electronic devices.

Concerning the audio experience or audio impression of electronic devices, it is known in the prior art to personalize mobile telephones by downloading new ring tones to the mobile telephones, for thereby changing the ring tone over time. This can e.g. be done by downloading the ring tones from remote servers provided by various service providers. However, changing or personalizing the audio experience or audio impression of mobile telephones in this way requires the user's intervention.

The visual experience or visual impression of electronic devices, as distinct from the audio experience of mobile phones, is however still relatively constant over time. That is, the visual appearance or semblance of electronic devices is more or less the same during the lifetime of the electronic device itself.

Accordingly, there is a need for providing an electronic device, a method and a computer program product that mitigate, alleviate or eliminate one or more of the above-mentioned deficiencies or disadvantages in the known prior art. More specifically, there is a need for providing a solution that makes the visual appearance of an electronic device variable over time. Preferably, it should also be possible to obtain the variable visual appearance of the electronic device by only little or, preferably, no user intervention at all.

### SUMMARY OF THE INVENTION

According to a first aspect of the invention, an electronic device comprises a user interface comprising a display and a keypad, a lighting device coupled to the user interface, the lighting device being adapted to provide an illumination effect to at least one of the display and the keypad to thereby illuminate at least one of the display and the keypad, and a calendar unit. A detector is coupled to the calendar unit, the detector being adapted to detect a calendar event generated from the calendar unit. Also, a controller is coupled to the lighting device and the detector, the controller being adapted to control the illumination effect of the lighting device in dependence of the detected calendar event.

The calendar event may be a certain point of time, e.g. hour, day, month, or year.

The controller may be adapted to send a control signal to the lighting device when a certain calendar event is detected by the detector, the control signal requesting the lighting device to provide a certain illumination effect being associated with the detected certain calendar event. The lighting device may be adapted to receive the control signal and in response thereto generate the certain illumination effect.

The lighting device may be adapted to provide the illumination effect, the illumination effect comprising a light emitted from the lighting device.

The lighting device may be adapted to provide the illumination effect, the illumination effect comprising a certain luminance of the light emitted from the lighting device.

The lighting device may be adapted to provide the illumination effect, the illumination effect comprising a light emitted from the lighting device, wherein the luminance of the light is increasing over a predetermined time period.

The lighting device may be adapted to provide the illumination effect, the illumination effect comprising a pulsating or flashing light emitted from the lighting device.

The lighting device may be adapted to provide the illumination effect, the illumination effect comprising a light emitted from the lighting device, wherein the emitted light has a wavelength within an electromagnetic spectrum of approximately 380 nm to 740 nm, i.e. the visible spectrum of humans.

The lighting device may be adapted to provide the illumination effect, the illumination effect comprising light emitted from the lighting device and the wavelength of the emitted light is continuously varied over a predetermined time period, such that the wavelength of the emitted light changes continuously from one wavelength to another wavelength within the predetermined time period.

The lighting device may be adapted to provide the illumination effect, the illumination effect being a theme which is provided to the display.

The user interface may further comprise a loudspeaker coupled to the controller and adapted to output a sound effect. The controller may be further adapted to control the sound effect of the loudspeaker in dependence to the detected calendar event.

The sound effect may be a music sound or a ring tone.

The electronic device may further comprise a timer adapted to determine a time elapsed between two detected calendar events. The controller may be further adapted to send a control signal to the lighting device for changing the illumination effect from a first illumination effect to a second illumination effect when the elapsed time has exceeded a threshold value.

The electronic device may also comprise a positioning unit coupled to the controller, wherein the positioning unit is adapted to determine the location of the electronic device. The controller may be adapted to control the illumination effect of the lighting device in dependence of the determined location. Additionally, or alternatively, the controller may be adapted to control the sound effect of the loudspeaker in dependence of the determined location.

The electronic device may be a device from the group comprising: a portable radio communication equipment, a mobile radio terminal, a mobile telephone, a cellular telephone, a pager, a communicator, an electronic organizer, a smart phone and a computer.

According to a second aspect of the invention, a method for controlling an illumination effect of a user interface of an electronic device comprises providing an illumination effect to at least one of a display and a keypad of the user interface to thereby illuminate at least one of the display and the keypad, detecting a calendar event from a calendar unit, and controlling the illumination effect in dependence of a detected calendar event.

The method may further comprise providing a sound effect to a loudspeaker of the user interface, and controlling the sound effect in dependence of the detected calendar event.

The method may further comprise determining a location of the electronic device, and controlling the illumination effect in dependence of the determined location. The method may additionally, or alternatively, comprise controlling the sound effect in dependence of the determined location.

According to a third aspect of the invention, a computer program product comprises computer program code means for controlling an illumination effect of a user interface of an electronic device when said computer program code means is executed by means of an electronic device having computer capabilities, the computer program code means comprising code means for providing an illumination effect to at least one of a display and a keypad of the user interface to thereby illuminate at least one of the display and the keypad, code means for detecting a calendar event from a calendar unit, and code means for controlling the illumination effect in dependence of a detected calendar event.

By providing a lighting device the illumination effect of which is controllable by a controller in dependence of a detected calendar event, e.g. a meeting appointment, a birthday, etc., it is possible to change or personalize the illumination effect provided to a keypad and/or a display of an electronic device over time. Thus, some embodiments of the invention provide a solution for making the visual appearance of electronic devices changeable over time, in dependence of detected calendar events. It is an advantage with embodiments of the invention that the visual appearance of electronic devices can be changed over time, since this may enhance the user experience of the electronic device. As emotional design of electronic devices is now of increasing interest, this solution is therefore also believed to become an important feature of electronic devices in the future.

Some embodiments of the invention also provide a solution for making the audio appearance variable over time. By providing a loudspeaker the sound effect or sound output of which is controllable by a controller in dependence of a detected calendar event, it is possible to change or personalize the sound effect over time.

Yet further, according to some embodiments of the invention there is little or no need for user intervention for changing or personalizing the audio and/or visual appearance of the electronic device during its lifetime. Thus, some embodiments of the invention provide a more automatic manner for changing or personalizing the audio and/or visual appearance of the electronic device than what is offered by known techniques.

Still further, some embodiments provide a solution for making the audio and/or visual appearance of electronic devices variable over time not only in dependence of a calendar event but also based on a determined location of the electronic device. This has the advantageous effect that the visual and/or audio appearance can be changed in dependence of where the electronic device is located at the moment, and in turn this may enhance the user experience of electronic devices even further.

### BRIEF DESCRIPTION OF THE DRAWINGS

Further objects, features and advantages of the invention will appear from the following detailed description of embodiments of the invention, wherein embodiments of the invention will be described in more detail with reference to the accompanying drawings, in which:

FIG. 1 is a schematic view of an electronic device embodied as a mobile telephone;

FIG. 2 is a block diagram of an embodiment of the mobile telephone of FIG. 1;

FIG. 3 is a block diagram of another embodiment of the mobile telephone of FIG. 1;

FIG. 4 is a block diagram of still another embodiment of the mobile telephone of FIG. 1; and

FIG. 5 is a flow chart illustrating a method according to an embodiment of the invention.

### DETAILED DESCRIPTION OF EMBODIMENTS

Embodiments of the present invention will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

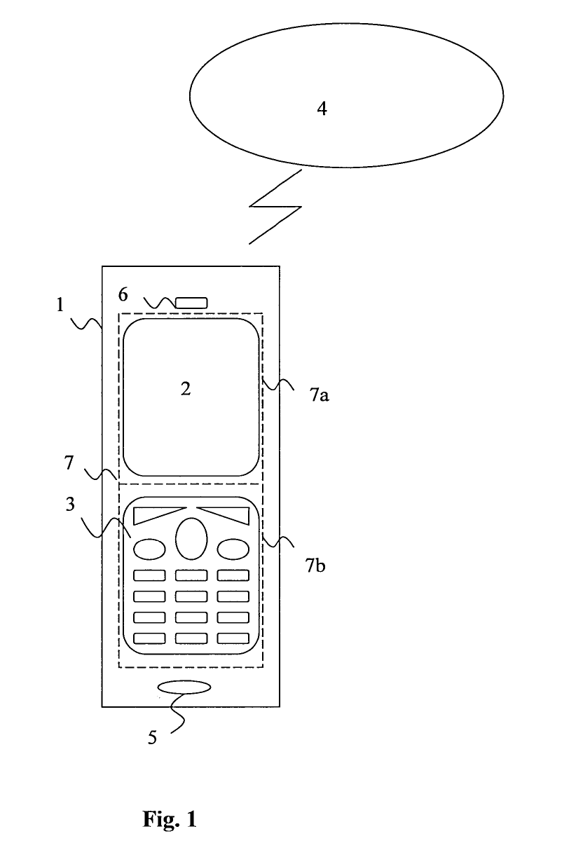

FIG. 1 illustrates an electronic device embodied as a mobile telephone 1. Embodiments of the invention may be implemented into a wide variety of electronic devices. The electronic device may e.g. be a mobile radio terminal, a pager, a communicator, a smart phone, a Personal Digital Assistant (PDA), an electronic organizer, a computer, etc. Reference will however be to a mobile telephone 1 below, which is only for illustrative purpose and should not be considered as limiting to the embodiments of the invention set forth herein.

In the embodiment shown in FIG. 1, the mobile telephone 1 comprises a display 2, e.g. a Liquid Crystal Display (LCD), in which data can be displayed or rendered. The mobile telephone 1 also comprises a keypad 3 with one or more keys for inputting information or commands to the mobile telephone 1. Moreover, the mobile telephone comprises a built-in antenna (not shown) for receiving/transmitting signals to and from a communication network 4 through which the mobile telephone 1 can communicate with other electronic devices. The mobile telephone 1 also comprises a microphone 5, through which the user may speak during a call. Still further, the mobile telephone 1 comprises a loudspeaker 6 through which a user may hear a call or listen to music.

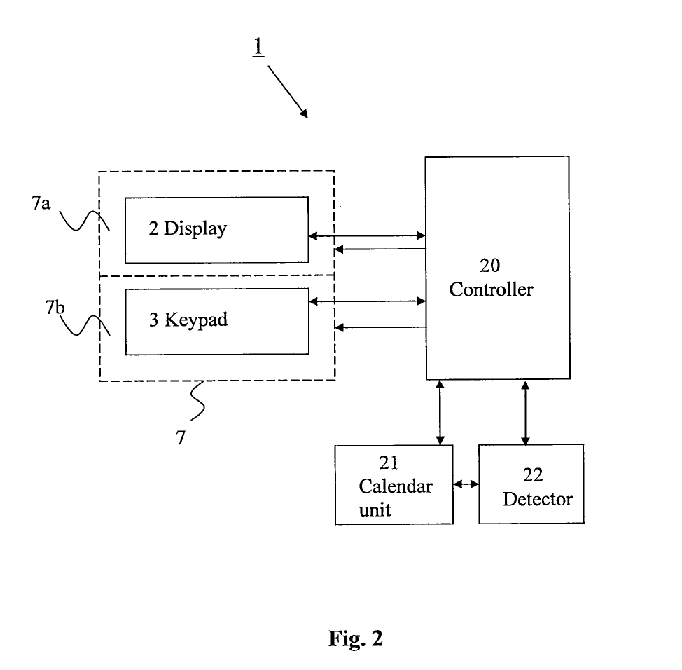

The mobile telephone 1 further comprises a lighting device 7 configured to provide an illumination effect to the display 2 and/or the keypad 3 for thereby illuminating or lighting the display 2 and/or the keypad 3. As used herein the term illumination effect is used to mean any light emitted from the lighting device 7 to illuminate the display 2 and/or keypad 3. The lighting device 7 is adapted to be controlled in accordance with a control signal transmitted from a later-mentioned controller (FIG. 2). The lighting device 7 may be a back light device adapted to illuminate the display 2 and/or the keypad 3 from behind. Moreover, the lighting device 7 may be comprised of a light-emitting diode (LED) device, such as a RGB LED device. In some embodiments, the lighting device is provided by a first back light device 7a for illuminating the display 2 and a second back light 7b for illuminating the keypad 3. Since the display 2 and/or the keypad 3 can be illuminated, a user may e.g. be helped to clearly read on the display and/or correctly select a desired key of the keypad even at night or even in poor lighting circumstances.

FIG. 2 illustrates an embodiment of the mobile telephone 1 shown in FIG. 1. The mobile telephone 1 comprises a controller 20 adapted to turn on and off the lighting device 7. Furthermore, the controller 20 is adapted to control the illumination effect provided by means of the lighting device 7 to illuminate the display 2 and/or the keypad 3. The controller 20 is further configured to control the lighting device 7 to provide one or more illumination effects to the display 2 and/or keypad 3. An illumination effect may be the luminance of the light i.e. the illumination level of the emitted light from the lighting device 7. Furthermore, an illumination effect may be a pulsating or flashing light. Yet further, an illumination effect may be light having a certain wavelength within the visible spectrum of humans, i.e. light within the electromagnetic spectrum of approximately 380 nm to 740 nm. That is, as perceived by human eyes, the illumination effect may be light of different colors. Moreover, an illumination effect may comprise light emitted from the lighting device 7, which is continuously variable over a predetermined time period. That is, the wavelength of the emitted light can change continuously from one wavelength to another wavelength within the predetermined time period. As a consequence, as perceived by human eyes the color of the emitted light can change continuously over the predetermined time period. Still further, an illumination effect may be emitted light, the luminance of which is increasing over a predetermined time period. If more than one illumination effect is provided by means of the lighting device 7 to the display 2 and/or keypad 3, any two or more of the above-mentioned illumination effects could be combined in any combination, either separately or simultaneously.

In the mobile telephone 1 illustrated in FIG. 1, the controller 20 may send a control signal to the lighting device 7 requesting the lighting device 7 to provide one or more of the above-mentioned illumination effects to the display 2 and/or keypad 3, such that the display 2 and/or keypad 3 becomes illuminated accordingly. When the illumination effect is provided to the display 2 only, the illumination effect may further comprise a theme. As used herein the term ‘theme’ refers to the general visual appearance of the parts of the display 2 and includes inter alia color schemes for menus and highlights, background images and, user and folder icons, etc. For example, an illumination effect could be changing the color of the emitted light, as perceived by human eyes, in association with any objects, i.e. menus, background images, icons, etc, displayed on the display 2 such that the color of the displayed objects may be varied over time.

The mobile telephone 1 also comprises a calendar unit 21 having a calendar function. The calendar function includes calendar events such as certain points of time, hours, days, weeks, months, years, etc. The user of the mobile telephone 1 may interact with and operate the calendar function to input, edit or erase calendar events such as birthdays, meeting appointments, certain special dates such as Valentine's Day, etc. Furthermore, a detector 22 is electronically coupled to the calendar unit 21 to identify or determine various calendar events, e.g. certain points of time, days, weeks, months, years, birthdays etc. Although the detector 22 and the calendar unit 21 are illustrated as separate units in FIG. 1, these two units could equally possible be integrated into one single unit.

The controller 20 is electronically coupled to the detector 22. The controller 20 is further adapted to send a control signal to the lighting device 7 when a certain calendar event, e.g. a birthday, a meeting appointment, etc., has been detected by the detector 22, for thereby requesting the lighting device 7 to provide a certain illumination effect that is associated with the detected certain calendar event. Furthermore, the lighting device 7 is adapted to receive the above-mentioned control signal and in response thereto generate and provide the certain illumination effect to at least one of the display 2 and the keypad 3.

Since the certain illumination effect is associated with a certain calendar event, it is possible to illuminate the display 2 and/or keypad 3 differently over time in dependence of different detected calendar events. This allows the mobile telephone 1 to change or personalize the visual appearance or impression of the mobile telephone 1 over time, in that the display 2 and/or keypad 3 can be provided with different illumination effects at different dates, months, years, etc. For example, this may allow the display 2 and/or keypad 3 to be provided with a red light, i.e. light with a wavelength of about 625 nm-740 nm, on Valentine's Day. Similarly, this may allow the display 2 and/or keypad 3 to provide a light, which pulsates or flashes when a detected calendar event is a meeting appointment of a certain kind. The association between certain calendar events and certain illumination effects could be pre-programmed in the mobile telephone 1 or, alternatively, be edited or programmed by the user of the mobile telephone 1 by interacting with and operating the user interface of the mobile telephone 1.

In one embodiment, the lighting device 7 is adapted to provide the illumination effect to the display 2 and the keypad at the same time, such that e.g. a displayed snowflake icon may sail down from the display 2 and then “continue” into and through the keypad 3.

In some embodiments, the mobile telephone 1 further comprises a timer (not shown), e.g. integral with the detector 22, which is adapted to determine a time elapsed between two detected calendar events. If so, the controller may be further adapted to the send a control signal to the lighting device 7, such that the lighting device 7 changes the illumination effect from a first illumination effect, e.g. light emitted in red color, to a second illumination effect, e.g. light emitted in blue color, when the elapsed time has exceeded a threshold value. This way, the visual appearance being perceived by human eyes from the illuminated display 2 and/or keypad 3 can be changed when the time elapsed between two detected calendar events has exceeded a certain amount of time.

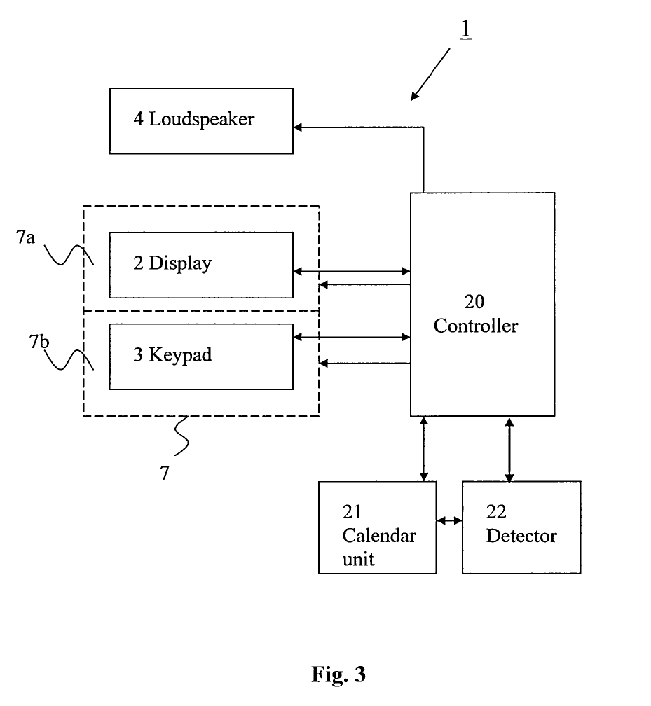

FIG. 3 illustrates another embodiment of the mobile telephone 1 illustrated in FIG. 1. As is shown in FIG. 3, the mobile telephone 1 comprises similar elements or units as the mobile telephone 1 of FIG. 2. In addition, the mobile telephone 1 of the embodiment shown in FIG. 3 comprises a loudspeaker 4, which is electrically coupled to the controller 20. In the embodiment shown in FIG. 3, the controller 20 is additionally adapted to send a control signal to the loudspeaker when a certain event is detected by the detector, for thereby requesting the loudspeaker to output a certain sound effect that is associated with the detected certain calendar event. The loudspeaker, in turn, is adapted to receive the control signal and in response thereto generate and provide the certain sound effect. The sound effect may e.g. be a ringtone or a music sound of any known format such as MP3, AAC, etc.

In addition to the technical effects and advantages of the mobile telephone 1 of FIG. 2, the mobile telephone of FIG. 3 has e.g. the further advantage that the loudspeaker 4 can output different ring tones over time in dependence of different detected calendar events. This allows the mobile telephone 1 to change or personalize the audio appearance or impression of the mobile telephone over time. The loudspeaker may e.g. be pre-designed to output different ring tones when a call is received by the mobile telephone in dependence of different dates, months, years, etc. For example, this may allow the loudspeaker 4 to output a love song as the ringtone on Valentine's Day. Again, the association between certain calendar events, such as certain days, and certain illumination effects may be pre-programmed in the mobile telephone 1 or, alternatively, be edited or programmed by the user of the mobile telephone 1 by interacting with and operating the user interface of the mobile telephone 1. Still further, this may allow the loudspeaker 4 to output different ringtones over the course of the year e.g. giving the ringtone a lighter and happier sound (on the minor tone scale) in the summer and a darker sound (on the major tone scale) in the winter.

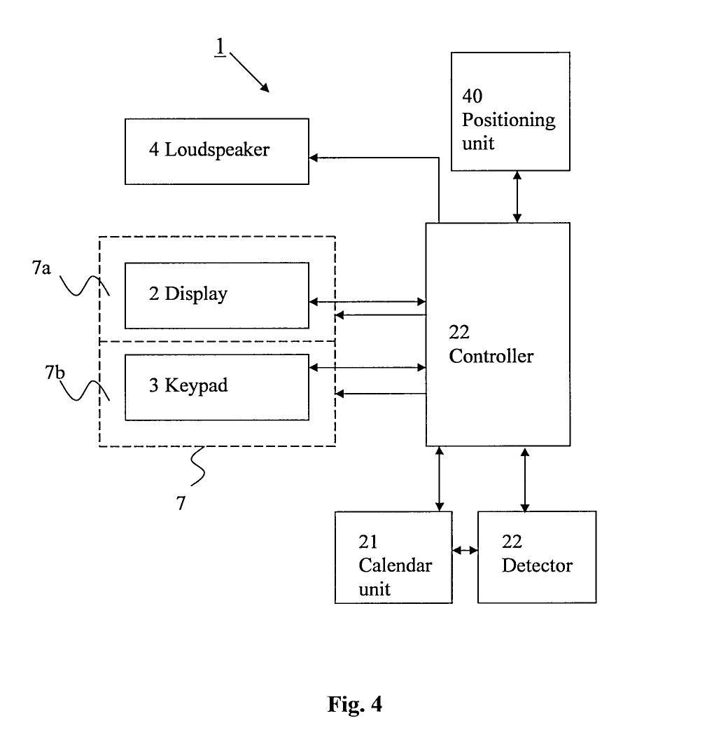

FIG. 4 illustrates still another embodiment of the mobile telephone 1 shown in FIG. 1. As is shown in FIG. 4, the mobile telephone 1 comprises similar elements or units as the mobile telephone 1 of the embodiment of FIG. 3. In addition, the mobile telephone 1 of FIG. 4 comprises a positioning unit 40 electrically coupled to the controller 20. The positioning unit 40 is adapted to determine the location of the mobile telephone 1. The positioning unit 40 may e.g. be a Global Positioning System (GPS) unit coupled to an antenna (not shown) for receiving GPS signals from GPS satellites. Additionally, or alternatively, the positioning unit 40 may be a positioning unit being adapted to determine the location of the mobile telephone by receiving positioning information from a telecommunication network 4. The controller 20 of the mobile telephone 1 shown in FIG. 4 is further adapted to control the illumination effect of the lighting device in dependence of the determined location of the mobile device 1. Additionally, or alternatively, the controller 20 of the mobile telephone 1 shown in FIG. 4 is adapted control the sound effect of the loudspeaker 4 in dependence of the determined location of the mobile device 1

In addition to the previously described technical effects and advantages of the mobile telephones 1 of FIG. 2 and FIG. 3, respectively, the mobile telephone 1 illustrated in FIG. 4 has the further advantage that the visual appearance of the display 2 and/or keypad 3 and/or the audio appearance of the loudspeaker 4 can be varied in dependence of the position of the mobile telephone 1. This allows the mobile telephone 1 to be changed or personalized based on where the mobile telephone 1 is located. As one illustrative example, certain Far Eastern music songs and/or Far Eastern themes can be provided through the user interface when the user and his/her mobile telephone 1 are located in the Arabic Peninsula. On the other hand, when the user and his/her mobile telephone 1 is located in Scandinavia, it is possible to provide an audio and/or visual appearance of the user interface of the mobile telephone 1 which is of a more Scandinavian style. Still further, another example is that certain office related visual and/or sound effects could be provided when located at office locations, whereas more personal visual and/or sound effects could be effectuated when located at home or outdoors. The association between certain locations and certain illumination effects and/or sound effects may be pre-programmed in the mobile telephone 1 or, alternatively, be edited or programmed by the user of the mobile telephone 1 by interacting with and operating the user interface of the mobile telephone 1.

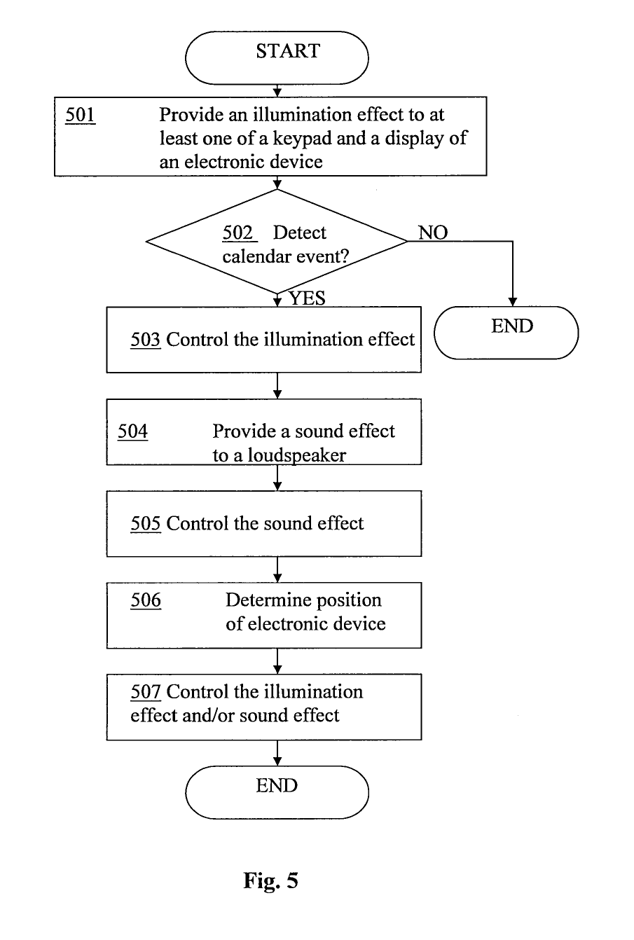

FIG. 5 illustrates a method of controlling an illumination effect of a user interface of an electronic device 1 according to an embodiment of the invention. In step 501, an illumination effect to at least one of a display and a keypad of the user interface is provided. Thus, at least one of the display and the keypad is illuminated. In a further step, step 502, it is detected whether a calendar event has been generated from a calendar unit. When no calendar event is detected, the method terminates. When a calendar event is detected, the method proceeds to step 503. In step 503, the illumination effect provided to either or both of the display and the keypad is controlled in dependence of the calendar event that was detected in the previous step 502. In some embodiments, the method may further comprise a step 504 for also providing a sound effect to a loudspeaker of the user interface, and a step 505 for controlling the sound effect in dependence of the calendar event that was detected in step 502. In yet further embodiments, the method may additionally, or alternatively, comprise a step 506 for determining a location of the electronic device 1, and a step 507 for controlling either or both of the illumination effect and the sound effect in dependence of the determined location. For the purpose of controlling the illumination effect of the user interface of the electronic device 1, not all method steps 501-507 are necessary. Rather, only method steps 501-503 need to be performed for this purpose. However, the method steps 504-507 are optional method steps which may contribute to further advantageous embodiments of the invention.

The method according to the invention may be executed by computer program code means to make an electronic device having computer capabilities, e.g. a mobile telephone, execute the method according to the invention when the computer program code means is run by the electronic device having computer capabilities. The computer program code means may be embodied on a computer readable medium, such as a memory.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

The present invention has been described above with reference to specific embodiments. However, other embodiments than those described are possible within the scope of the invention. For example, it is possible to provide an electronic device, which is capable of only providing a sound effect in dependence of the detected calendar event and, hence, not necessarily providing both a sound effect and an illumination effect in combination. Yet further, it is possible to provide an electronic device, which is capable of providing a sound effect and/or illumination effect in dependence of only the determined location of the mobile telephone 1 and, hence, not necessarily in dependence of a combination of both a detected calendar event and a determined location of the mobile telephone 1. Different method steps than those described above, performing the method by hardware or software or a combination of both hardware and software may be provided within the scope of the invention. The different features and method steps of the invention can be combined in other combinations than those described. The invention is only limited by the appended patent claims.

1. An electronic device, comprising:
a user interface comprising a display and a keypad;
a lighting device coupled to the user interface, the lighting device being adapted to provide an illumination effect to at least one of the display and the keypad to thereby illuminate at least one of the display and the keypad; and
a calendar unit; wherein
a detector is coupled to the calendar unit, the detector being adapted to detect a calendar event generated from the calendar unit; and
a controller is coupled to the lighting device and the detector, the controller being adapted to control the illumination effect of the lighting device in dependence of the detected calendar event.

2. The electronic device according to claim 1, wherein:
the controller is adapted to send a control signal to the lighting device when a certain calendar event is detected by the detector, the control signal requesting the lighting device to provide a certain illumination effect being associated with the detected certain calendar event, and
the lighting device is adapted to receive the control signal and in response thereto generate the certain illumination effect.

3. The electronic device according to claim 2, wherein the lighting device is adapted to provide the illumination effect, the illumination effect comprising a light emitted from the lighting device.

4. The electronic device according to claim 2, wherein the lighting device is adapted to provide the illumination effect, the illumination effect comprising a certain luminance of the light emitted from the lighting device.

5. The electronic device according to claim 2, wherein the lighting device is adapted to provide the illumination effect, the illumination effect comprising a luminance which is increasing over a predetermined time period.

6. The electronic device according to claim 2, wherein the lighting device is adapted to provide the illumination effect, the illumination effect comprising a pulsating or flashing light emitted from the lighting device.

7. The electronic device according to claim 2, wherein the lighting device is adapted to provide the illumination effect, the illumination effect comprising a light emitted from the lighting device and the emitted light has a wavelength within an electromagnetic spectrum of approximately 380 nm to 740 nm, i.e. the visible spectrum of humans.

8. The electronic device according to claim 2, wherein the lighting device is adapted to provide the illumination effect, the illumination effect comprising light emitted from the lighting device and the wavelength of the emitted light is continuously varied over a predetermined time period, such that the wavelength of the emitted light changes continuously from one wavelength to another wavelength within the predetermined time period.

9. The electronic device according to claim 2, wherein the lighting device is adapted to provide the illumination effect, the illumination effect being a theme which is provided to the display.

10. The electronic device according to claim 1, the user interface further comprising a loudspeaker coupled to the controller and adapted to output a sound effect, wherein the controller is further adapted to control the sound effect of the loudspeaker in dependence to the detected calendar event.

11. The electronic device according to claim 10, wherein the sound effect is a music sound or a ring tone.

12. The electronic device according to claim 1, wherein the calendar event is a certain point of time, e.g. hour, day, month, or year.

13. The electronic device according to claim 12, further comprising a timer adapted to determine a time elapsed between two detected calendar events, wherein the controller is further adapted to send a control signal to the lighting device for changing the illumination effect from a first illumination effect to a second illumination effect when the elapsed time has exceeded a threshold value.

14. The electronic device according to claim 1, further comprising: a positioning unit coupled to the controller and further adapted to determine the location of the electronic device, wherein the controller is adapted to control the illumination effect of the lighting device in dependence of the determined location.

15. The electronic device according to claim 10, further comprising: a positioning unit coupled to the controller and further adapted to determine the location of the electronic device, wherein the controller is adapted to control the sound effect of the loudspeaker in dependence of the determined location.

16. The electronic device according to claim 1, wherein the electronic device is a device from the group comprising: a portable radio communication equipment, a mobile radio terminal, a mobile telephone, a cellular telephone, a pager, a communicator, an electronic organizer, a smart phone and a computer.

17. A method for controlling an illumination effect of a user interface of an electronic device, the method comprising:
providing an illumination effect to at least one of a display and a keypad of the user interface to thereby illuminate at least one of the display and the keypad,
detecting a calendar event from a calendar unit; and
controlling the illumination effect in dependence of a detected calendar event.

18. The method according to claim 17, the method further comprising:
providing a sound effect to a loudspeaker of the user interface; and
controlling the sound effect in dependence of the detected calendar event.

19. The method according to claim 17, the method further comprising:
determining a location of the electronic device;
controlling the illumination effect in dependence of the determined location.

20. The method according to claim 18, the method further comprising;
determining a location of the electronic device;
controlling the sound effect in dependence of the determined location.

21. A computer program product comprising computer program code means for controlling an illumination effect of a user interface of an electronic device when said computer program code means is executed by means of an electronic device having computer capabilities, the computer program code means comprising:
code means for providing an illumination effect to at least one of a display and a keypad of the user interface to thereby illuminated at least one of the display and the keypad,
code means for detecting a calendar event from a calendar unit; and
code means for controlling the illumination effect in dependence of a detected calendar event.
